(19) United States
(12) Patent Application Publication
(10) Pub. No.: US 2026/0131914 A1
(43) Pub. Date: May 14, 2026

(54) CONTROL METHOD, GIMBAL, FLYING OBJECT, GIMBALED FLYING OBJECT, AND PROGRAM

(71) Applicant: Sony Group Corporation, Tokyo (JP)

(72) Inventor: Kouji MIYATA, Tokyo (JP)

(73) Assignee: Sony Group Corporation, Tokyo (JP)

(21) Appl. No.: 18/869,289

(22) PCT Filed: May 19, 2023
(86) PCT No.: PCT/JP2023/018713

§ 371 Date: Jul. 2, 2025

(30) Foreign Application Priority Data
Jun. 8, 2022 (JP) 2022-092676
Jul. 29, 2022 (JP) 2022-121579

(51) Int. Cl. B64U 20/87; B64D 47/08; B64U 101/30

(52) U.S. Cl. CPC B64U 20/87; B64D 47/08; B64U 2101/30

(57) ABSTRACT

A control method according to the present technology controls a pitch angle of a gimbal independently of a pitch angle of a flying object, the gimbal being installed on the flying object and capable of rotating a camera in a pitch direction and a roll direction, and controls a roll angle of the gimbal in correlation with a roll angle of the flying object.

### TECHNICAL FIELD

The present technology relates to a technology of controlling the orientation of a camera in a gimbal that is installed on a flying object such as a drone and holds the camera.

### BACKGROUND ART

In recent years, aerial photography in which a camera is attached to a drone to capture images by this camera has become widely known. Generally, such a camera is held by a gimbal and its orientation is controlled.

A lock mode, a follow mode, and a first person view (FPV) mode are known as gimbal control modes. In the lock mode, the camera maintains a specified angle (azimuth) in the roll direction, the pitch direction, and the yaw direction. In the follow mode, the camera follows the attitude of the airframe only in the yaw direction among the roll direction, the pitch direction, and the yaw direction. In the FPV mode, the camera follows the attitude of the airframe in the roll direction, the pitch direction, and the yaw direction.

Note that Patent Literature 1 below is related to the present technology.

### CITATION LIST

### Patent Literature

Patent Literature 1: International Publication No. 2007/097431

### DISCLOSURE OF INVENTION

### Technical Problem

A new, non-conventional gimbal control mode is required.

In view of the circumstances as described above, it is an object of the present technology to provide technologies of a new, non-conventional gimbal control mode and the like.

### Solution to Problem

A control method according to the present technology includes: controlling a pitch angle of a gimbal independently of a pitch angle of a flying object, the gimbal being installed on the flying object and capable of rotating a camera in a pitch direction and a roll direction; and controlling a roll angle of the gimbal in correlation with a roll angle of the flying object.

This makes it possible to provide a new, non-conventional gimbal control mode.

A control method according to another aspect of the present technology includes changing a pitch angle of a gimbal in accordance with an orientation of a velocity vector in a movement of a flying object, the gimbal being installed on the flying object and capable of rotating a camera in a pitch direction.

A gimbal according to the present technology includes a control unit. The control unit controls a pitch angle of the gimbal independently of a pitch angle of a flying object, the gimbal being installed on the flying object and capable of rotating a camera in a pitch direction and a roll direction, and controls a roll angle of the gimbal in correlation with a roll angle of the flying object.

A flying object according to the present technology includes a control unit. The control unit controls a pitch angle of a gimbal independently of a pitch angle of the flying object, the gimbal being installed on the flying object and capable of rotating a camera in a pitch direction and a roll direction, and controls a roll angle of the gimbal in correlation with a roll angle of the flying object.

A gimbaled flying object according to the present technology includes a control unit. The control unit controls a pitch angle of a gimbal independently of a pitch angle of a flying object, the gimbal being installed on the flying object and capable of rotating a camera in a pitch direction and a roll direction, and controls a roll angle of the gimbal in correlation with a roll angle of the flying object.

A program according to the present technology causes a computer to execute processing of controlling a pitch angle of a gimbal independently of a pitch angle of a flying object, the gimbal being installed on the flying object and capable of rotating a camera in a pitch direction and a roll direction, and controlling a roll angle of the gimbal in correlation with a roll angle of the flying object.

### BRIEF DESCRIPTION OF DRAWINGS

FIG. 1 is a diagram showing a control system according to a first embodiment of the present technology.

FIG. 2 is a block diagram showing the internal structure of a gimbaled drone.

FIG. 3 is a block diagram showing the internal structure of a controller.

FIG. 4 is a diagram showing the comparison between gimbal control modes in comparative examples and the present technology.

FIG. 5 is a diagram showing the processing of a control unit in the gimbaled drone.

FIG. 6 is a diagram showing a roll angle of the airframe of the drone.

FIG. 7 is a diagram showing the angle difference between a yaw angle of the airframe and a yaw angle of the gimbal (camera).

FIG. 8 is a diagram showing the relationship between the angle difference in the yaw direction and a roll angle of the gimbal (camera).

FIG. 9 is an partially enlarged diagram of FIG. 8, showing the relationship between Equations (1) to (3).

FIG. 10 is a diagram showing the drone and the camera as viewed from the directions A, B, C, D, E, and F shown in FIG. 8.

FIG. 11 is a diagram showing the processing of a control unit in a gimbaled drone in a second embodiment.

FIG. 12 is a diagram showing the processing of a control unit in a third embodiment.

FIG. 13 is a diagram showing the relationship between a velocity vector in the movement of the airframe of the drone and a pitch angle of the gimbal (camera).

FIG. 14 is a diagram showing the relationship between a velocity vector in the movement of the airframe of the drone and a pitch angle of the gimbal (camera).

### MODE(S) FOR CARRYING OUT THE INVENTION

Hereinafter, embodiments according to the present technology will be described with reference to the drawings.

### First Embodiment

### <Overall Configuration and Configuration of Each Unit>

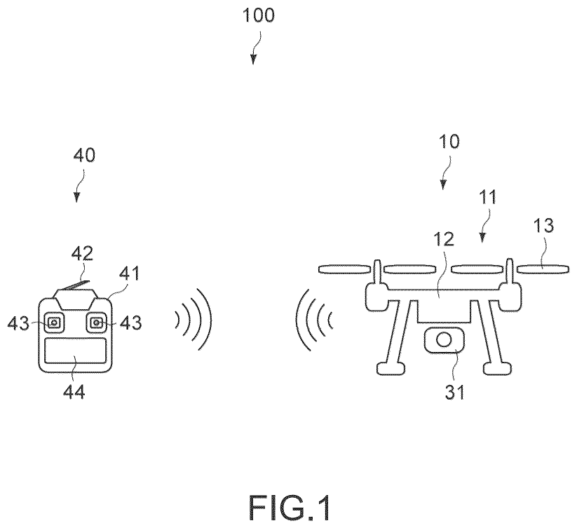

FIG. 1 is a diagram showing a control system 100 of a first embodiment of the present technology. As shown in FIG. 1, the control system 100 includes a gimbaled drone 10 and a controller 40.

### [Gimbaled Drone 10]

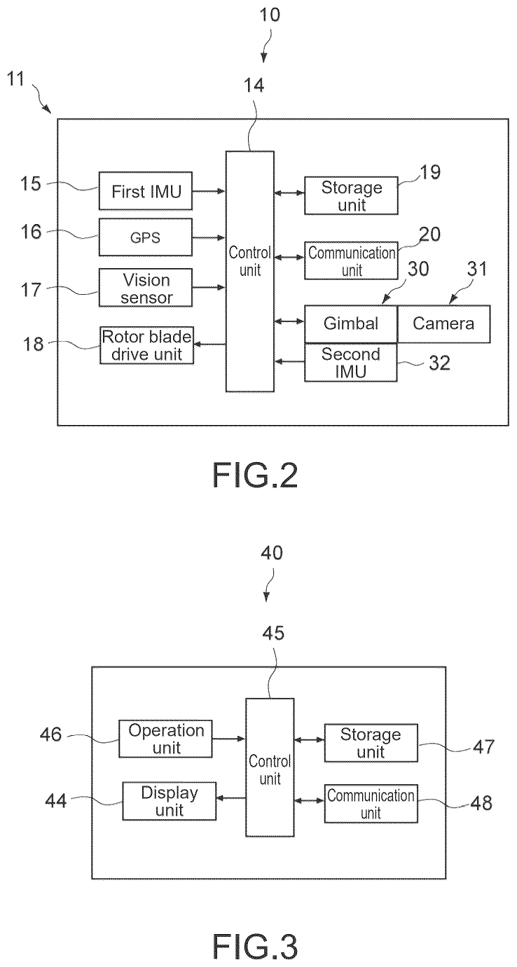

The gimbaled drone 10 includes a drone 11 (flying object), a camera 31, and a gimbal 30 (see FIG. 2) that is attached to the drone 11 and holds the camera 31.

The drone 11 (flying object) includes an airframe 12 and a plurality of rotor blades 13 provided to the airframe 12. The drone 11 is capable of performing various movements, such as forward/backward and right/left movements, ascending and descending operations, and turning operations, by controlling the drive of the rotor blades 13.

Here, the drone 11 is an example of a flying object. The flying object is not limited to the drone 11, but can also be a radio-controlled airplane or helicopter, etc. Typically, the flying object can be any device that can fly (and is relatively small).

FIG. 2 is a block diagram showing the internal configuration of the gimbaled drone 10. As shown in FIG. 2, the gimbaled drone 10 includes a control unit 14, a first inertial measurement unit 15 (IMU), a global positioning system 16 (GPS), a vision sensor 17, a rotor blade drive unit 18, a storage unit 19, a communication unit 20, a gimbal 30, a camera 31, and a second IMU 32.

The control unit 14 performs various calculations on the basis of various programs stored in the storage unit 19 and comprehensively controls each unit of the gimbaled drone 10.

The control unit 14 is achieved by hardware or a combination of hardware and software. The hardware is configured as part or all of the control unit 14, and examples of the hardware include a central processing unit (CPU), a graphics processing unit (GPU), a vision processing unit (VPU), a digital signal processor (DSP), a field programmable gate array (FPGA), an application specific integrated circuit (ASIC), or a combination of two or more of those above. Note that the same holds true for a control unit 45 of the controller 40.

The first IMU 15 is provided in the airframe 12 of the drone 11. The first IMU 15 includes an acceleration sensor that detects accelerations in the three-axis directions in the drone 11, an angular velocity sensor that detects angular velocities around the three axes in the drone 11, and the like. The first IMU 15 transmits the detected acceleration information and angular velocity information to the control unit 14.

The GPS 16 generates GPS position information on the basis of signals from a plurality of GPS satellites and outputs the GPS position information to the control unit 14.

The vision sensor 17 is, for example, a stereo camera 31, and outputs the acquired image information to the control unit 14.

The control unit 14 integrates the acceleration information and the angular velocity information from the first IMU 15, the GPS information from the GPS 16, and the image information from the vision sensor 17, and estimates the self-position and attitude of the airframe 12 of the drone 11 on the basis of those pieces of information.

The rotor blade drive unit 18 is, for example, an electric speed controller (ESC), a motor, etc., and drives the rotor blades 13 in response to control by the control unit 14.

The storage unit 19 includes a non-volatile memory in which various programs necessary for processing by the control unit 14 and various types of data are stored, and a volatile memory used as the work area of the control unit 14.

Note that the various programs described above may be read from a portable recording medium such as an optical disc or a semiconductor memory, or may be downloaded from a server device on a network. The same holds true for the programs of the controller 40.

The communication unit 20 is configured to be capable of communicating with the controller 40 and external devices (e.g., server device on a network).

The gimbal 30 is, for example, attached to the underside of the airframe 12 of the drone 11 and holds the camera 31. The gimbal 30 is capable of rotating the camera 31 in the roll direction, the pitch direction, and the yaw direction.

Note that, in the description herein, the terms of a roll angle, a pitch angle, and a yaw angle of the airframe 12 of the drone 11, and a roll angle, a pitch angle, and a yaw angle of the gimbal 30 (camera 31) are used and mean a roll angle, a pitch angle, and a yaw angle in the global coordinate system.

The second IMU 32 is provided at the position closest to the leading end in the gimbal 30, i.e., at the position where the gimbal 30 holds the camera 31 and moves integrally with the camera 31. Note that the second IMU 32 may be provided to the camera 31.

The second IMU 32 includes an acceleration sensor that detects accelerations in the three-axis directions in the gimbal 30 (camera 31), an angular velocity sensor that detects angular velocities around the three axes in the gimbal 30 (camera 31). The second IMU 32 transmits the detected acceleration information and angular velocity information to the control unit 14 as attitude information of the gimbal 30 (camera 31).

The camera 31 is a camera 31 for aerial photography and is held by the gimbal 30 to control its attitude (orientation). The camera 31 captures any images in accordance with the control of the control unit 14.

### [Controller 40]

The controller 40 is a device for the user to control the movement of the drone 11, the movement of the gimbal 30, the timing of image capturing of the camera 31, and the like. As shown in FIG. 1, the controller 40 includes a housing 41, an antenna 42, two control sticks 43, and a display unit 44.

The antenna 42 is configured to be capable of transmitting and receiving signals to and from the gimbaled drone 10.

The two control sticks 43 are each assigned various operations such as forward/backward and right/left movements, ascending and descending operations, and turning operations of the drone 11.

The display unit 44 displays various images on the screen. The screen of the display unit 44 may be provided with a proximity sensor that detects the proximity of the user's finger, or other sensors.

FIG. 3 is a block diagram showing the internal structure of the controller 40. As shown in FIG. 3, the controller 40 includes a control unit 45, an operation unit 46, the display unit 44, a storage unit 47, and a communication unit 48.

The control unit 45 performs various calculations on the basis of various programs stored in the storage unit 47 and comprehensively controls each unit of the controller 40.

The operation unit 46 includes the two control sticks 43, the proximity sensor provided on the screen of the display unit 44, and the like. The operation unit 46 detects user's operations and outputs operation signals corresponding to the operations to the control unit 45.

The storage unit 47 includes a non-volatile memory in which various programs necessary for processing by the control unit 45 and various types of data are stored, and a volatile memory used as the work area of the control unit 45. The communication unit 48 is configured to be capable of communicating with the gimbaled drone 10 and external devices (e.g., server device on a network) via the antenna 42.

Note that, in the example shown in FIG. 1, the controller 40 is a dedicated controller 40, but a general-purpose device such as a smartphone or a tablet personal computer (PC) may be used as the controller 40. Alternatively, for example, a smartphone or the like may be connected to the dedicated controller 40 including the control sticks 43 to form an integrated controller 40.

### <Comparison Between Gimbal Control Modes>

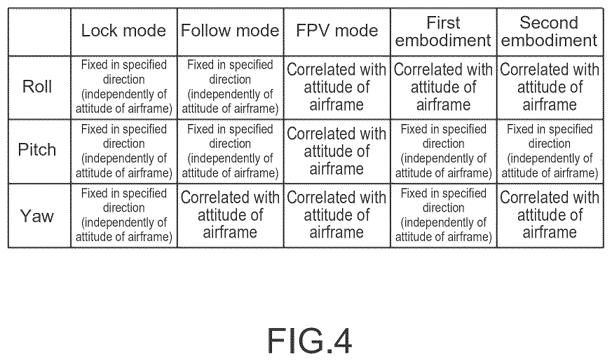

Next, comparison between gimbal control modes in comparative examples and the present technology will be described. FIG. 4 is a diagram showing comparison between gimbal control modes in comparative examples and the present technology.

As shown in FIG. 4, in the lock mode (comparative example), the gimbal 30 (camera 31) is fixed in a specified direction in all the roll, pitch, and yaw directions (controlled independently of the attitude of the airframe 12 of the drone 11).

Further, in the follow mode (comparative example), the gimbal 30 (camera 31) is fixed in a specified direction in the roll and pitch directions (controlled independently of the attitude of the airframe 12 of the drone 11), while the gimbal 30 is correlated with the attitude of the airframe 12 of the drone 11 in the yaw direction.

Further, in the FPV mode (comparative example), the gimbal 30 (camera 31) is correlated with the attitude of the airframe 12 of the drone 11 in all the roll, pitch, and yaw directions.

In contrast to the above, in the first embodiment of the present technology, the gimbal 30 (camera 31) is controlled to be correlated with the attitude of the airframe 12 of the drone 11 in the roll direction, while it is fixed in a specified direction in the pitch and yaw directions (controlled independently of the attitude of the airframe 12 of the drone 11).

Further, in the second embodiment of the present technology, the gimbal 30 (camera 31) is controlled to be correlated with the attitude of the airframe 12 of the drone 11 in the roll and yaw directions, while it is fixed in a specified direction in the pitch direction (controlled independently of the airframe 12 of the drone 11).

In such a manner, the present technology provides new, non-conventional gimbal control modes.

Note that, in the description of this embodiment, the wording that the attitude of the gimbal 30 (camera 31) (pitch and yaw: first embodiment, pitch only: second embodiment) is controlled “independently of” the attitude of the airframe 12 of the drone 11 (pitch and yaw: first embodiment, pitch only: second embodiment) means that the attitude of the gimbal 30 (camera 31) is not in a relationship matched with or corelated with the attitude of the airframe 12 of the drone 11.

Further, in the description of this embodiment, the wording that the attitude of the gimbal 30 (camera 31) (roll only: first embodiment, roll and yaw: second embodiment) is controlled to be “correlated with” the attitude of the airframe 12 of the drone 11 (roll only: first embodiment, roll and yaw: second embodiment) includes both the cases where the attitude of the gimbal 30 (camera 31) is in a relationship matched with or corelated with the attitude of the airframe 12 of the drone 11. Note that the “correlation” includes the case where they are correlated using a reflection rate to be described below.

### <Description of Operation>

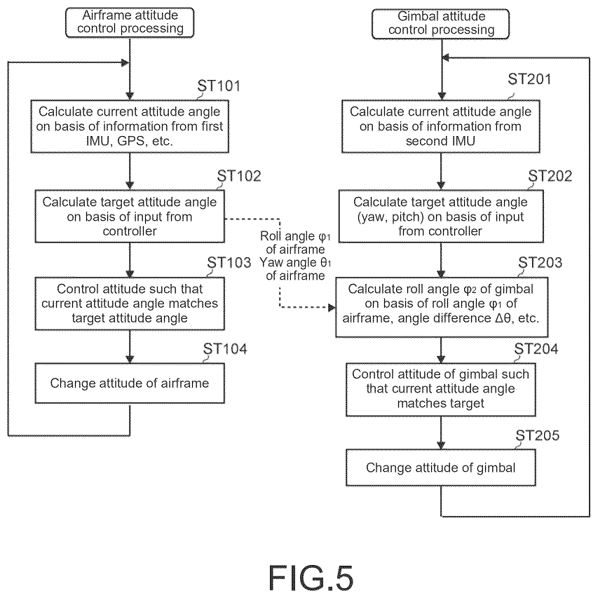

Next, the processing of the control unit 14 in the gimbaled drone 10 will be described. FIG. 5 is a diagram showing the processing of the control unit 14 in the gimbaled drone 10. The description here corresponds to the first embodiment in FIG. 4. As shown in FIG. 5, the control unit 14 simultaneously and concurrently performs airframe attitude control processing for controlling the attitude of the airframe 12 of the drone 11 and gimbal attitude control processing for controlling the attitude of the gimbal 30 (camera 31).

### [Attitude Control Processing for Airframe 12]

First, the airframe attitude control processing will be described. The control unit 14 integrates the information from the first IMU 15, the GPS 16, and the vision sensor 17 to estimate the current self-position and attitude of the airframe 12 and calculate the current attitude angle of the airframe 12 (Step 101).

Next, the control unit 14 calculates target attitude angles (roll angle φ1, pitch angle ψ1, yaw angle θ1) of the airframe 12 on the basis of the input values from the controller 40 (information such as velocity, angle, etc. of drone 11) (Step 102). The target roll angle φ1 and yaw angle θ1 of the airframe 12, which are obtained at that time, are used to calculate a roll angle φ2 of the gimbal 30 (camera 31) in the gimbal attitude control processing to be described below.

Next, the control unit 14 controls the attitude of the airframe 12 of the drone 11 by driving the rotor blades 13 such that the current attitude angle matches the target attitude angle (roll angle φ1, pitch angle ψ1, yaw angle θ1) (Step 103). This changes the attitude of the airframe 12 of the drone 11 (Step 104), and the control unit 14 returns to Step 101 thereafter. The processing from Step 101 to Step 104 is repeated in a predetermined cycle.

### [Attitude Control Processing for Gimbal 30]

Next, the attitude control processing for the gimbal 30 (camera 31) will be described. The control unit 14 calculates the current attitude angle of the gimbal 30 (camera 31) on the basis of the information of the second IMU 32 (Step 201).

Next, the control unit 14 calculates the target attitude angle (pitch angle ψ2, yaw angle θ2) of the gimbal 30 (camera 31) on the basis of the input values from the controller 40 (angle, etc. of gimbal 30 (camera 31)) (Step 202).

Note that the values obtained in Step 202 are only the pitch angle ψ2 (fixed in a specified direction) and the yaw angle θ2 (fixed in a specified direction) of the gimbal 30 (camera 31), and the roll angle φ2 of the gimbal 30 (camera 31) will be obtained in Step 203 to be described below.

In Step 203, the control unit 14 calculates the roll angle φ2 of the gimbal 30 (camera 31) on the basis of the roll angle φ1 of the airframe 12, the angle difference Δθ (=θ2−θ1) between the yaw angle θ1 of the airframe 12 and the yaw angle θ2 of the gimbal 30 (camera 31), and the like, and sets this roll angle φ2 as the target roll angle φ2.

In Step 203, the following Equations (1) to (3) are specifically used.

$$roll\_b = sin φ 1 \qquad ( 1 )$$

$$roll\_g = roll\_b \times cos Δ θ \qquad ( 2 )$$

$$φ 2 = a \times atan ( roll\_g / {( {1}^{2} - {roll\_g}^{2} )}^{1 / 2} ) \qquad ( 3 )$$

Here, in Equation (1), roll_b is a roll component of the tilt of the airframe 12, and φ1 is a roll angle of the airframe 12. Further, in Equation (2), roll_g is a roll component of the tilt of the gimbal 30, and Δθ is an angle difference between the yaw angle θ1 of the airframe 12 (nose direction) and the yaw angle θ2 of the gimbal 30 (camera 31) (front direction of camera 31) (Δθ=θ2−θ1). Further, in Equation (3), φ2 is a roll angle of the gimbal 30 (camera 31), and a is a reflection rate indicating how much the roll angle φ1 of the airframe 12 is reflected in the roll angle φ2 of the gimbal 30.

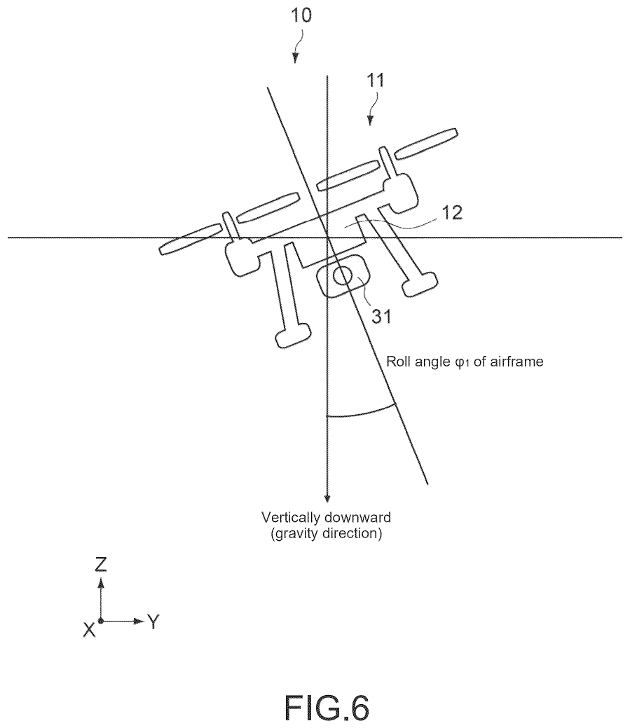

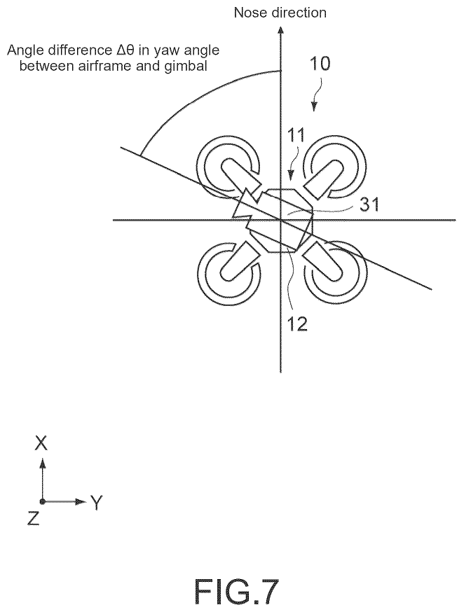

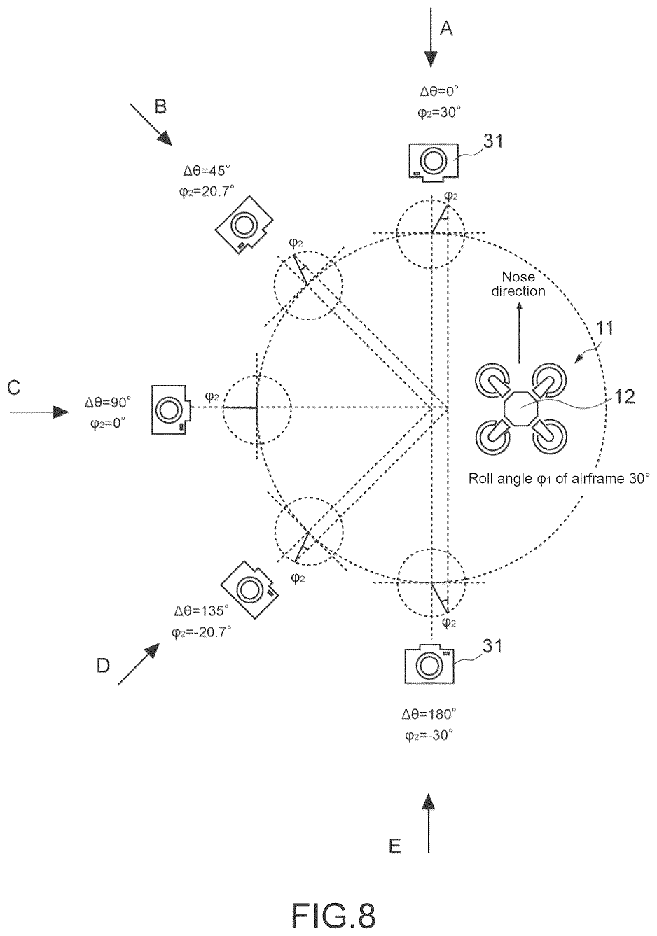

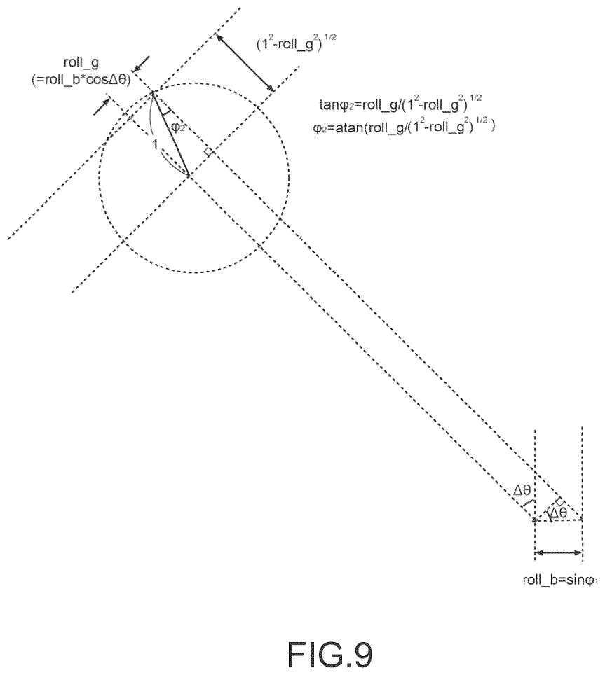

FIG. 6 is a diagram showing the roll angle φ1 of the airframe 12 of the drone 11. FIG. 7 is a diagram showing the angle difference Δθ between the yaw angle θ1 of the airframe 12 and the yaw angle θ2 of the gimbal 30 (camera 31). FIG. 8 is a diagram showing the relationship between the angle difference Δθ in the yaw direction and the roll angle φ2 of the gimbal 30 (camera 31). FIG. 9 is a partially enlarged view of FIG. 8, showing the relationship between Equations (1) to (3).

Referring to FIG. 9, the roll component of the tilt of the airframe 12, roll_b, is expressed as sin φ1 using the roll angle φ1 of the airframe 12 (Equation (1)). Further, the roll component of the tilt of the gimbal 30, roll_g, is expressed as roll_b×cos Δθ using the roll component of the tilt of the airframe 12, roll_b, and the angle difference Δθ in the yaw direction (Equation (2)).

The diagonal of the right triangle shown in the unit circle is 1, the sine component is roll_g, and the cosine component is (roll_g/(1²−roll_g²)^{1/2}). Thus, tan φ2=roll_g/(1²−roll_g²)^{1/2}, and φ2=atan(roll_g/(1²−roll_g²)^{1/2}). The equation in which the reflection rate a is multiplied by this right-hand side is Equation (3) above.

In this embodiment, the roll angle φ2 of the gimbal 30 is controlled to eventually take the value of φ2 expressed by Equation (3).

Note that, as expressed in Equations (1) to (3) above, in this embodiment, the roll angle φ1 of the gimbal 30 is related to the roll component roll_b of the tilt of the airframe 12, the roll angle φ1 of the airframe 12, the roll component roll_g of the tilt of the gimbal 30, the yaw angle θ1 of the airframe 12, the yaw angle θ2 of the gimbal 30, the angle difference Δθ in the yaw direction, the reflection rate a, etc., and the roll angle φ2 of the gimbal 30 is controlled on the basis of those values (those values are reflected in the roll angle φ2 of the gimbal 30).

FIG. 8 shows the roll angle φ2 of the gimbal 30 when the angle difference Δθ in the yaw direction is 0°, 45°, 90°, 135°, and 180°. Note that the example shown in FIG. 8 is an example when the roll angle φ1 of the airframe 12 is 30° and the reflection rate a is 1.

In this case, when the angle difference Δθ in the yaw direction is 00, 45°, 90°, 135°, and 180°, the roll angle φ2 of the gimbal 30 (camera 31) is, in turn, 30°, 20.7°, 0°, −20.7°, and −30°.

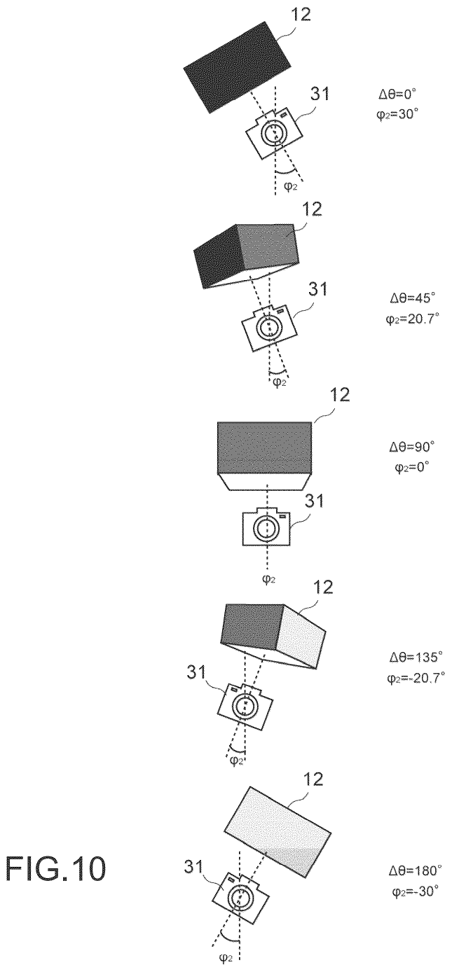

FIG. 10 shows the drone 11 and the camera 31 as seen from the directions A, B, C, D, E, and F shown in FIG. 8. Note that in FIG. 10 the airframe 12 is represented by a cuboid, with the front of the airframe 12 in black, the left side of the airframe 12 in dark gray, the back of the airframe 12 in light gray, and the bottom of the airframe 12 in white. Further, in FIG. 10, the pitch angle ψ2 of the gimbal 30 (camera 31) is set to 0° (fixed at a specified angle).

As shown in the top figure of FIG. 10, when the angle difference Δθ in the yaw direction is 0°, the roll angle φ2 of the gimbal 30 (camera 31) is controlled to take the same value as the roll angle φ1 of airframe 12 (the value reflects the reflection rate when the reflection rate is set to a value other than 1).

Further, as shown in the bottom figure of FIG. 10, when the angle difference Δθ in the yaw direction is 180°, the roll angle θ2 of the gimbal 30 (camera 31) is controlled to take the same value as the roll angle φ1 of the airframe 12 in the opposite direction (the value reflects the reflection rate when the reflection rate is set to a value other than 1).

Further, as shown in the third figure from the top in FIG. 10, when the angle difference Δθ in the yaw direction is 90°, the roll angle φ2 of the gimbal 30 (camera 31) is controlled to be 0° regardless of the roll angle φ1 of the airframe 12 (unrelated to the reflection rate).

Further, as shown in the top figure, the second figure from the top, and the third figure from the top in FIG. 10, when the angle difference Δθ in the yaw direction is 0°<Δθ<90°, the roll angle φ2 of the gimbal 30 (camera 31) is controlled to gradually decrease as the angle difference Δθ increases.

Further, as shown in the third figure from the top, the fourth figure from the top, and the bottom figure in FIG. 10, when the angle difference Δθ in the yaw direction is 90°<Δθ<180°, the roll angle φ2 of the gimbal 30 (camera 31) is controlled to gradually increase in the opposite direction of the case where 0°<Δθ<90° as the angle difference Δθ increases.

Note that the case where the angle difference Δθ in the yaw direction is 0°≤Δθ≤180° (left side of FIG. 8) has been described here, but the same holds true for the case where the angle difference Δθ in the yaw direction is 0°≥Δθ≥−180° (right side of FIG. 8). This is because cos(Δθ)=cos(−Δθ) for cos Δθ in Equation (2) above.

In other words, when the angle difference Δθ in the yaw direction is −90°, the roll angle φ2 of the gimbal 30 (camera 31) is controlled to be 0° regardless of the roll angle φ1 of the airframe 12 (unrelated to the reflection rate).

Further, when the angle difference Δθ in the yaw direction is 0°>Δθ>−90°, the roll angle φ2 of the gimbal 30 (camera 31) is controlled to gradually decrease as the absolute value of the angle difference Δθ increases.

Further, when the angle difference Δθ in the yaw direction is 90°>Δθ>−180°, the roll angle φ2 of the gimbal 30 (camera 31) is controlled to gradually increase in the opposite direction of the case where 0°>Δθ>−90° as the absolute value of the angle difference Δθ increases.

Next, the reflection rate a will be described. The reflection rate a typically takes a value in the range of x≤a≤y. For example, x is set to 0.5, and for example, y is set to 1.5. Note that if the reflection rate is 1, the roll angle φ2 of the gimbal 30 matches the roll angle φ1 of the airframe 12 when the angle difference Δθ is 0. Further, if the reflection rate a is zero, the gimbal 30 (camera 31) does not rotate in the roll direction regardless of the angle difference Δθ (in the present technology, the roll angle φ2 of the gimbal 30 reflects the roll angle φ1 of the airframe 12, and thus the reflection rate is not set to zero).

This reflection rate a may be set in advance as a fixed value that cannot be changed, or it may be set as a variable value that can be changed. If the reflection rate a is set as a variable value, the reflection rate a may be changeable in response to user instructions or may be automatically changeable by the control unit 14 (the reflection rate a may be controlled to be variable).

Returning back to FIG. 5, the control unit 14 calculates a target roll angle φ2 of the gimbal 30 in Step 203, and then proceeds to the next Step 204. In Step 204, the control unit 14 controls the attitude of the gimbal 30 (camera 31) such that the current attitude angle of the gimbal 30 (camera 31) matches the target attitude angle (roll angle φ2, pitch angle ψ2, yaw angle θ2).

This changes the attitude of the gimbal 30 (Step 205), and then the control unit 14 returns to Step 201. The processing from Step 201 to Step 205 is repeated in a predetermined cycle.

Note that in the description in FIG. 5 the case where the attitude angle of the airframe 12 as a target value is used for the roll angle φ1 of the airframe 12 and the yaw angle θ1 of the airframe 12 that are used in Step 203 has been described. On the other hand, the current attitude angle of the airframe 12 may be used as the roll angle φ1 of the airframe 12 and the yaw angle θ1 of the airframe 12 that are used in Step 203 (see Step 101).

Further, in the description in FIG. 5, the case where the control unit 14 of the drone 11 executes the airframe attitude control processing and the gimbal attitude control processing has been described. On the other hand, a control unit may be provided to the gimbal 30, and the control unit 14 of the drone 11 may perform the airframe attitude control processing and the control unit of the gimbal 30 may perform the gimbal attitude control processing. Alternatively, the control unit of the gimbal 30 may perform the airframe attitude control processing and the gimbal attitude control processing.

Alternatively, the airframe attitude control processing and the gimbal attitude control processing may be executed by the control unit 45 of the controller 40 or may be executed by a server device on the network. Alternatively, the airframe attitude control processing and the gimbal attitude control processing may be shared and executed by two or more of the control unit 14 of the drone 11, the control unit of the gimbal 30, the control unit 45 of the controller 40, and the server device on the network. Note that the same holds true for a second embodiment to be described below.

### Actions, Etc.

As described above, in the control method according to this embodiment, the pitch angle ψ2 of the gimbal 30 (camera 31) is controlled independently of the pitch angle ψ1 of the airframe 12, while the roll angle φ2 of the gimbal 30 (camera 31) is controlled in correlation with the roll angle φ1 of the airframe 12.

It is assumed that when the angle difference Δθ in the yaw direction is 0°, the airframe 12 is tilted forward (tilted in the pitch direction) in order for the drone 11 to move forward in the nose direction. In this case, the pitch angle ψ2 of the gimbal 30 (camera 31) is fixed in a specified direction. For example, if the pitch angle ψ2 of the gimbal 30 (camera 31) is 0°, the gimbal 30 (camera 31) is not tilted forward, and the camera 31 images the horizontal direction.

On the other hand, it is assumed that when the angle difference Δθ in the yaw direction is 0°, the airframe 12 is tilted (banked) in the roll direction. In this case, the roll angle φ2 of the gimbal 30 changes in accordance with the roll angle φ1 of the airframe 12, and the camera 31 captures an image that appropriately reflects the banking of the airframe 12.

Here, generally, the user assumes an aerial video that reflects the banking (rotation in the roll direction) of the airframe 12, such as aerial videos of airplanes. In this embodiment, as described above, the pitch angle of the airframe 12 is not reflected in the pitch direction of the gimbal 30 (camera 31), and the roll angle of the airframe 12 is reflected in the roll direction of the gimbal 30, so that an aerial video that reflects the banking (rotation in the roll direction) of the airframe 12, such as aerial videos of airplanes, can be captured. Therefore, it is possible to acquire an image that is close to the aerial video assumed by the user.

Furthermore, in the control method according to this embodiment, the yaw angle θ2 of the gimbal 30 is controlled independently of the yaw angle θ1 of the airframe 12. In addition to this, even when there is an angle difference Δθ in the yaw direction, the roll angle φ2 of the gimbal 30 reflects the roll angle φ1 of the airframe 12. This makes it possible to acquire an image that is closer to the aerial video assumed by the user.

Further, in this embodiment, the roll angle φ2 of the gimbal 30 is changed in accordance with the angle difference Δθ in the yaw direction.

Referring to FIG. 10, particularly in this embodiment, when the angle difference Δθ in the yaw direction is 0°, the roll angle φ2 of the gimbal 30 (camera 31) is controlled to take the same value as the roll angle φ2 of the airframe 12 (the value reflecting the reflection rate when the reflection rate is set to a value other than 1). Further, when the angle difference Δθ in the yaw direction is 180°, the roll angle φ2 of the gimbal 30 (camera 31) is controlled to take the same value as the roll angle φ1 of the airframe 12 in the opposite direction (the value reflecting the reflection rate when the reflection rate is set to a value other than 1).

Further, when the angle difference Δθ in the yaw direction is 90°, the roll angle φ2 of the gimbal 30 (camera 31) is controlled to be 0° regardless of the roll angle φ1 of the airframe 12 (unrelated to the reflection rate).

Further, when the angle difference Δθ in the yaw direction is 0°<Δθ<90°, the roll angle φ2 of the gimbal 30 (camera 31) is controlled to gradually decrease as the angle difference Δθ increases.

Further, when the angle difference Δθ in the yaw direction is 90°<Δθ<180°, the roll angle φ2 of the gimbal 30 (camera 31) is controlled to gradually increase in the opposite direction of the case where 0°<Δθ<90°, as the angle difference Δθ increases.

Further, when the angle difference Δθ in the yaw direction is −90°, the roll angle φ2 of the gimbal 30 (camera 31) is controlled to be 0° regardless of the roll angle φ1 of the airframe 12 (unrelated to the reflection rate).

Further, when the angle difference Δθ in the yaw direction is 0°>Δθ>−90°, the roll angle φ2 of the gimbal 30 (camera 31) is controlled to gradually decrease as the absolute value of the angle difference Δθ increases.

Further, when the angle difference Δθ in the yaw direction is 90°>Δθ>−180°, the roll angle φ1 of the gimbal 30 is controlled such that the roll angle φ2 of the gimbal 30 (camera 31) gradually increases in the opposite direction of the case where 0°>Δθ>−90° as the absolute value of the angle difference Δθ increases.

Here, if a user gets on an airplane and holds the camera to capture images of the outside (forward, backward, sideward, etc.) from the airplane, the user often turns the camera in the orientations shown in FIG. 10 as described here. In other words, in this embodiment, it is possible to acquire an image that is closer to the aerial video assumed by the user.

### Second Embodiment

Next, a second embodiment of the present technology will be described. In the second and subsequent embodiments, the points that differ from the first embodiment described above will be mainly described.

The main difference between the first and second embodiments is that in the first embodiment, the yaw angle θ2 of the gimbal 30 (camera 31) is controlled independently of the yaw angle θ1 of the airframe 12 (fixed in a specified direction), whereas in the second embodiment, the yaw angle θ2 of the gimbal 30 (camera 31) is controlled to be correlated with the yaw angle θ1 of the airframe 12 (see FIG. 4).

Typically, in the second embodiment, the yaw angle θ2 of the gimbal 30 (camera 31) matches the yaw angle θ1 of the airframe 12. In other words, the angle difference Δθ in the yaw direction is always zero (the second embodiment can also be regarded as the form in which the angle difference Δθ in the yaw direction is always zero in the first embodiment).

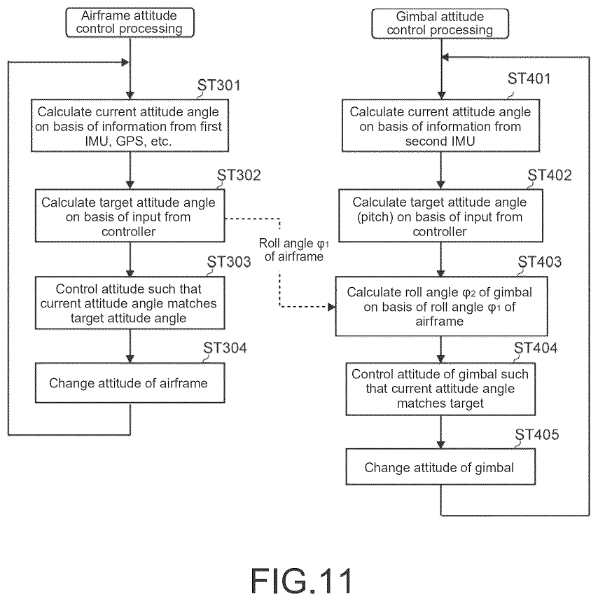

FIG. 11 is a diagram showing the processing of the control unit 14 in the gimbaled drone 10 in the second embodiment. Steps 301 to 304 in the airframe attitude control processing of FIG. 11 are typically the same as Steps 101 to 104 in the airframe attitude control processing of FIG. 5.

In the gimbal attitude control processing, the control unit 14 first calculates the current attitude angle of the gimbal 30 (camera 31) on the basis of the information of the second IMU 32 (Step 401).

Next, the control unit 14 calculates a target attitude angle (pitch angle ψ2) of the gimbal 30 (camera 31) on the basis of the input values from the controller 40 (angle, etc. of gimbal 30 (camera 31)) (Step 402).

Note that the value obtained in Step 402 is only the pitch angle ψ2 of the gimbal 30 (camera 31) (fixed in a specified direction). The yaw angle θ2 of the gimbal 30 matches the yaw angle θ1 of the airframe 12, and the roll angle φ2 of the gimbal 30 (camera 31) is obtained in Step 403 to be described below.

In Step 403, the control unit 14 calculates the roll angle φ2 of the gimbal 30 (of the camera 31) on the basis of the roll angle φ1 of the airframe 12, and sets it as the target roll angle.

In Step 403, the following Equation (4) is specifically used.

$$φ 2 = a \times φ 1 \qquad ( 4 )$$

The reference symbol a is the reflection rate indicating how much the roll angle φ1 of the airframe 12 is reflected in the roll angle φ2 of the gimbal 30.

Next, the control unit 14 controls the attitude of the gimbal 30 (camera 31) such that the current attitude angle of the gimbal 30 (camera 31) matches the target attitude angle (roll angle φ2, pitch angle ψ2, yaw angle θ2) (Step 404).

This changes the attitude of the gimbal 30 (Step 405), and the control unit 14 then returns to Step 401. The processing from Step 401 to Step 405 is repeatedly executed in a predetermined cycle.

In the second embodiment as well, as in the first embodiment described above, the pitch angle ψ2 of the gimbal 30 (camera 31) is controlled independently of the pitch angle ψ1 of the airframe 12, while the roll angle φ2 of the gimbal 30 (camera 31) is controlled in correlation with the roll angle φ1 of the airframe 12.

It is assumed that the airframe 12 is tilted forward (tilted in the pitch direction) in order for the drone 11 to move forward in the nose direction. In this case, the pitch angle ψ2 of the gimbal 30 (camera 31) is fixed in a specified direction. For example, if the pitch angle ψ2 of the gimbal 30 (camera 31) is 0°, the gimbal 30 (camera 31) is not tilted forward, and the camera 31 images the horizontal direction.

On the other hand, it is assumed that the airframe 12 is tilted (banked) in the roll direction. In this case, the roll angle φ2 of the gimbal 30 changes in accordance with the roll angle φ1 of the airframe 12, and the camera 31 captures an image that properly reflects the banking of the airframe 12.

As described above, in the second embodiment as well, as in the first embodiment, the pitch angle of the airframe 12 is not reflected in the pitch direction of the gimbal 30 (of the camera 31), and the roll angle of the airframe 12 is reflected in the roll direction of the gimbal 30, so that an aerial video that reflects the banking (rotation in the roll direction) of the airframe 12, such as aerial videos of airplanes, can be captured. Therefore, it is possible to acquire an image that is close to the aerial video assumed by the user.

### Third Embodiment

Next, a third embodiment of the present technology will be described. In the first and second embodiments described above, the gimbal 30 (camera 31) is fixed in a specified direction in the pitch direction.

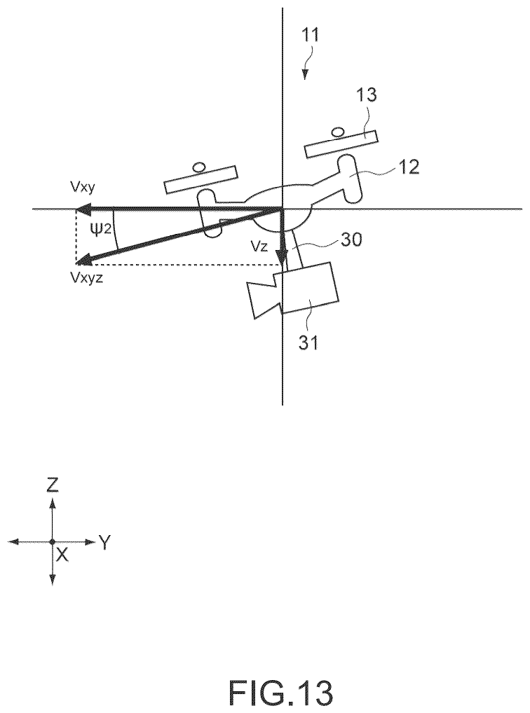

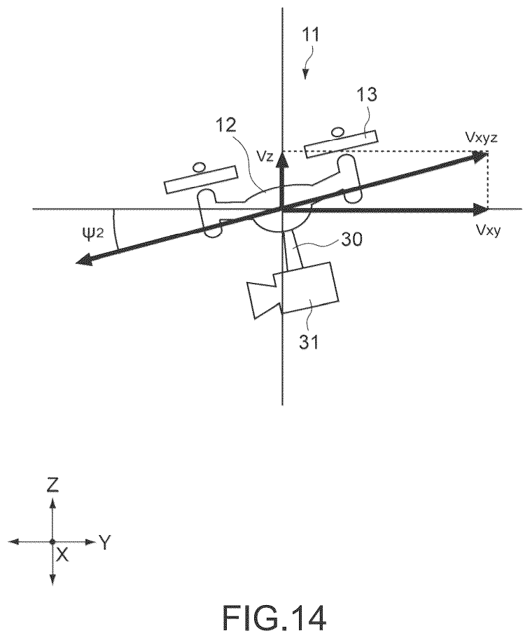

On the other hand, in the third embodiment, the pitch angle ψ2 of the gimbal 30 (camera 31) changes in accordance with the orientation of a velocity vector Vxyz in the movement of the airframe 12 of the drone 11 (see FIGS. 13 and 14 below for a velocity vector xyz). In other words, in the third embodiment, the pitch angle ψ2 of the gimbal 30 is controlled in correlation with the orientation of the velocity vector Vxyz (which is not the attitude angle of the drone 11) of the airframe 12 of the drone 11.

In the description of the third embodiment, the processing of changing the pitch angle of the gimbal 30 in accordance with the orientation of the velocity vector of the drone 11 will be described as applied to the first embodiment (i.e., roll angle of gimbal: correlated with the attitude of the airframe; pitch angle of gimbal: correlated with the velocity vector of the airframe; and yaw angle of gimbal: fixed in a specified direction). Therefore, the description of the third embodiment will focus on the points that differ from the first embodiment described above.

Note that the processing of changing the pitch angle ψ2 of the gimbal 30 in accordance with the orientation of the velocity vector of the drone 11 may be applied to the second embodiment described above (i.e., roll angle of gimbal: correlated with the attitude of the airframe; pitch angle of gimbal: correlated with the velocity vector of the airframe; and yaw angle of gimbal: correlated with the attitude of the airframe).

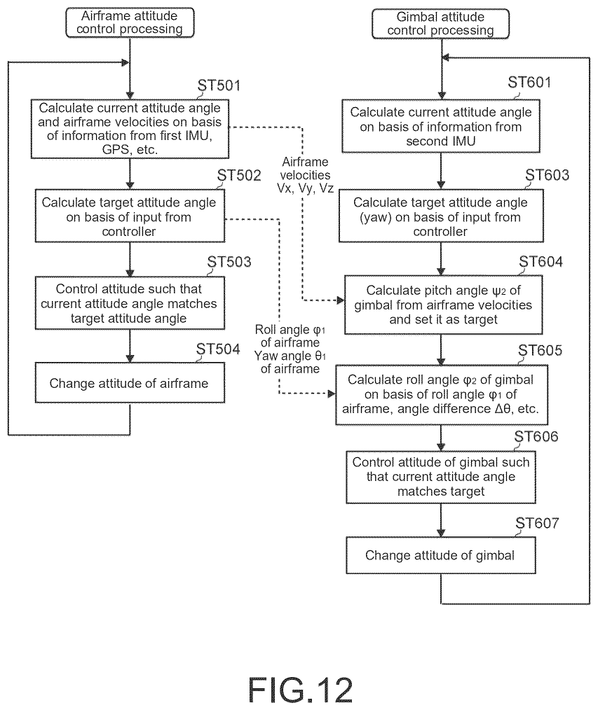

FIG. 12 is a diagram showing the processing of the control unit 14 in the third embodiment.

### [Attitude Control Processing for Airframe 12]

The control unit 14 integrates information from the first IMU 15, the GPS 16, and the vision sensor 17 to estimate the current self-position and attitude of the airframe 12 and calculate the current attitude angle of the airframe 12 (Step 501).

The control unit 14 also calculates the current airframe velocities Vx, Vy, and Vz of the airframe 12 on the basis of the information from the first IMU 15, the GPS 16, and the vision sensor 17 (Step 501). The information of the airframe velocities Vx, Vy, and Vz obtained at that time is used to calculate the pitch angle ψ2 of the gimbal 30 (camera 31) in the gimbal attitude control processing (see FIGS. 13 and 14 below).

Note that in Step 501, the control unit 14 may acquire information on wind speed of the airframe 12 of the drone 11 on the basis of the information from the first IMU 15, the GPS 16, the vision sensor 17, and the like.

Next, the control unit 14 calculates the target attitude angle (roll angle φ1, pitch angle ψ1, yaw angle θ1) of the airframe 12 on the basis of the input values from the controller 40 (Step 502). The target roll angle φ1 and yaw angle θ1 of the airframe 12 obtained at that time are used to calculate the roll angle φ2 of the gimbal 30 (camera 31) in the gimbal attitude control processing.

Note that if the control unit 14 has acquired the information on the wind speed of the airframe 12 of the drone 11, in Step 502, the control unit 14 may perform the processing for eliminating the effects of the wind speed on the roll angle φ1 of the airframe.

In other words, the control unit 14 adjusts the roll angle φ1 of the airframe such that the roll angle φ1 of the airframe becomes the target roll angle even if the airframe 12 is affected by the wind speed. Note that this processing is also applicable to the first and second embodiments described above.

Next, the control unit 14 controls the attitude of the airframe 12 of the drone 11 by driving the rotor blades 13 such that the current attitude angle matches the target attitude angle (roll angle φ1, pitch angle ψ1, yaw angle θ1) (Step 503).

### [Attitude Control Processing for Gimbal 30]

The control unit 14 calculates the current attitude angle of the gimbal 30 (camera 31) on the basis of the information of the second IMU 32 (Step 601).

Next, the control unit 14 calculates the target attitude angle (yaw angle θ2) of the gimbal 30 on the basis of the input values from the controller 40 (Step 602).

Note that the value obtained in Step 602 is only the yaw angle θ2 (fixed in the specified direction) of the gimbal 30 (camera 31). The pitch angle ψ2 of the gimbal 30 (camera 31) is obtained in Step 604 to be described below, and the roll angle φ2 of the gimbal 30 (camera 31) is obtained in Step 605 to be described below.

Note that the control unit 14 may calculate the target pitch angle of the gimbal 30 (camera 31) on the basis of the input values from the controller 40 and may add the pitch angle (dependent on velocity vector) calculated in Step 603 below to the target pitch angle.

In Step 604, the control unit calculates the pitch angle ψ2 of the gimbal on the basis of the airframe velocities Vx, Vy, and Vz of the drone 11 and sets it as the target pitch angle.

FIGS. 13 and 14 are diagrams showing the relationship between the velocity vector Vxyz in the movement of the airframe 12 of the drone 11 and the pitch angle ψ2 of the gimbal 30 (camera 31).

FIG. 13 shows the situation when the angle difference between a horizontal component Vxy in the velocity vector Vxyz of the airframe and the yaw angle θ2 of the gimbal 30 (camera 31) is 0°, and the front of the camera is turned in the direction matched with the orientation of the velocity vector Vxyz.

On the other hand, FIG. 14 shows the situation when the angle difference between the horizontal component Vxy in the velocity vector xyz of the airframe and the yaw angle θ2 of the gimbal 30 (camera 31) is 180°, and the front of the camera 31 is turned in the opposite direction of the orientation of the velocity vector Vxyz.

In Step 603, the control unit 14 first calculates the horizontal component Vxy of the velocity vector of the airframe on the basis of the airframe velocities Vx and Vy using the following Equation (5).

$$Vxy = + {( {Vx}^{2} + {Vy}^{2} )}^{1 / 2} , or - {( {Vx}^{2} + {Vy}^{2} )}^{1 / 2} \qquad ( 5 )$$

Note that, in Equation (5), one of the + sign and the − sign is used, which is determined as follows. First, if the angle difference between the horizontal component Vxy of the velocity vector of the airframe and the yaw angle θ2 of the gimbal 30 (camera 31) is less than ±90 (−90° to 90), the value of Vxy is set to be positive (see FIG. 13).

On the other hand, if the angle difference between the horizontal component Vxy of the velocity vector of the airframe and the yaw angle θ2 of the gimbal 30 (camera 31) exceeds ±90 (−90° to −180, 90° to) 180°, the value of Vxy is set to be negative (see FIG. 14).

Next, the control unit 14 calculates the pitch angle ψ2 of the gimbal 30 (camera 31) using the following Equation (6) if the value of Vxy is positive (see FIG. 13), or calculates the pitch angle ψ2 of the gimbal 30 (camera 31) using the following Equation (7) if the value of Vxy is negative (see FIG. 14).

$$ψ 2 = atan ( - Vz / Vxy ) \qquad ( 6 )$$

$$ψ 2 = atan ( Vz / - Vxy ) \qquad ( 7 )$$

In other words, in Step 604, the control unit 14 executes the processing of changing the pitch angle ψ2 of the gimbal 30 (camera 31) in accordance with the orientation of the velocity vector Vxyz in the movement of the airframe 12 of the drone 11.

The control unit 14 also changes the pitch angle ψ2 of the gimbal in accordance with the angle at which the velocity vector Vxyz is tilted with respect to the horizontal direction (XY plane). In particular, in the third embodiment, the pitch angle ψ2 of the gimbal 30 (camera 31) is changed such that the pitch angle ψ2 of the gimbal 30 (camera 31) matches the angle at which the velocity vector xyz is tilted with respect to the horizontal direction (XY plane). Here, matching is not limited to perfect matching, but may include some error (e.g., ±10°).

Note that a reflection rate may be used for how much the angle at which the velocity vector Vxyz is tilted with respect to the horizontal direction (XY plane) is reflected in the pitch angle ψ2 of the gimbal.

Further, under the condition that the yaw angle difference between the horizontal component Vxy of the velocity vector Vxyz and the yaw angle θ2 of the gimbal 30 (camera 31) is equal to or smaller than ±90° (first condition), the control unit 14 changes the pitch angle ψ2 of the gimbal 30 such that the front orientation of the camera 31 obtained by the change in the pitch angle ψ2 of the gimbal 30 is the orientation identical to the velocity vector of the drone 11 (see FIG. 13).

Further, under the condition that the yaw angle difference between the horizontal component Vxy of the velocity vector Vxyz and the yaw angle θ2 of the gimbal 30 (camera 31) exceeds ±90° (second condition), the control unit 14 changes the pitch angle ψ2 of the gimbal 30 such that the front orientation of the camera 31 obtained by the change in the pitch angle ψ2 of the gimbal 30 is the opposite orientation of the velocity vector of the drone 11 (see FIG. 14).

Note that the control unit 14 reverses the positive and negative signs of the pitch angle ψ2 of the gimbal 30 on the basis of the yaw angle difference between the horizontal component Vxy of the velocity vector Vxyz and the yaw angle θ2 of the gimbal 30 (camera 31).

In Step 604, after setting the pitch angle φ2 of the gimbal as the target value, the control unit 14 executes the processing of Step 605 and subsequent steps. Note that the processing of Step 605 and subsequent steps is the same as in the first embodiment described above, and thus the description thereof will be omitted here.

### Actions, Etc.

As described above, in the control method according to the third embodiment, the pitch angle ψ2 of the gimbal 30 (camera 31) is changed in accordance with the orientation of the velocity vector Vxyz in the movement of the airframe 12 of the drone 11. This makes it possible to not only capture an aerial video reflecting the banking (rotation in the roll direction) of the airframe 12, but also capture an aerial video reflecting the ascending and descending movements of the airframe 12.

This will be described in detail with reference to FIGS. 13 and 14.

In FIG. 13, the drone 11 is flying toward the lower left, and the velocity vector Vxyz is facing in the lower left direction. The yaw angle difference between the horizontal component Vxy of the velocity vector Vxyz and the yaw angle θ2 of the gimbal 30 is 0°.

Further, in FIG. 13, the pitch angle ψ2 of the gimbal 30 is set to the same angle as the angle (absolute value) at which the velocity vector xyz is tilted with respect to the horizontal plane, and the positive/negative sign of the pitch angles ψ2 is negative, which is the same as the pitch direction of the velocity vector Vxyz. As a result, the front orientation of the camera 31 is identical to the orientation of the velocity vector Vxyz. Therefore, the camera will image the lower left, which is the same orientation as that of the velocity vector.

In FIG. 14, the drone 11 is flying toward the upper right, and the velocity vector Vxyz is facing in the upper right direction. The yaw angle difference between the horizontal component Vxy of the velocity vector Vxyz and the yaw angle θ2 of the gimbal 30 is 180°.

Further, in FIG. 14, the pitch angle ψ2 of the gimbal 30 is set to the same angle as the angle (absolute value) at which the velocity vector xyz is tilted with respect to the horizontal plane, and the positive/negative sign of the pitch angle ψ2 is negative, which is opposite to the pitch direction of the velocity vector Vxyz. As a result, the front orientation of the camera 31 is exactly opposite to the orientation of the velocity vector Vxyz. Therefore, the camera will image the lower left, which is the exact opposite orientation of the orientation of the velocity vector.

Further, in the third embodiment, it is also possible for the drone 11 to perform imaging directly above (or conversely, directly below) when the drone 11 ascends vertically, and to perform imaging directly below (or conversely, directly above) when the drone 11 descends vertically.

As described above, in the third embodiment, it is possible to not only capture an aerial video that reflects the banking (rotation in the roll direction) of the airframe 12, but also capture an aerial video that reflects the ascending and descending movements of the airframe 12.

In the description of the third embodiment, the case where the processing of changing the pitch angle ψ2 of the gimbal 30 in accordance with the orientation of the velocity vector of the drone 11 is applied to the first embodiment has been described, but such processing may be applied to the second embodiment described above. Typically, the same processing as Step 604 only needs to be performed in the processing in the second embodiment (see FIG. 11).

In the second embodiment, the processing in which the yaw angle θ2 of the gimbal 30 is matched with the yaw angle θ1 of the airframe 12 is executed, so that in the yaw direction, the front of the camera 30 is basically facing in the nose direction of the drone 11.

This case will be described with reference to FIGS. 13 and 14. In FIG. 13, the drone 11 is flying toward the lower left on the forward side of the nose direction, and the velocity vector Vxyz is facing in the lower left direction. In this case, the camera will image the lower left, which is the same orientation as the orientation of the velocity vector, on the forward side of the nose direction.

In FIG. 14, the drone 11 is flying backward toward the upper right, and the velocity vector Vxyz is facing in the upper right direction. The backward flight is a method of flying with the nose direction as the back side. In this case, the camera 31 will image the lower left, which is the opposite orientation of that of the velocity vector, on the forward side of the nose direction.

In other words, in this case as well, as described above, it is possible to not only capture an aerial video that reflects the banking (rotation in the roll direction) of the airframe 12, but also capture an aerial video that reflects the ascending and descending movements of the airframe 12.

### Various Modified Examples

The present technology can also be configured as follows.
(1) A control method, including:
   controlling a pitch angle of a gimbal independently of a pitch angle of a flying object, the gimbal being installed on the flying object and capable of rotating a camera in a pitch direction and a roll direction; and
   controlling a roll angle of the gimbal in correlation with a roll angle of the flying object.
(2) The control method according to (1), in which
   the gimbal is capable of rotating the camera in a yaw direction, and
   the control method further includes
      controlling a yaw angle of the gimbal independently of a yaw angle of the flying object.
(3) The control method according to (1), in which
   the gimbal is capable of rotating the camera in a yaw direction, and
   the control method further includes
      controlling a yaw angle of the gimbal in correlation with a yaw angle of the flying object.
(4) The control method according to (2), in which
   the roll angle of the gimbal is controlled on the basis of the roll angle of the flying object.
(5) The control method according to (4), in which
   the roll angle of the gimbal is controlled on the basis of the yaw angle of the flying object.
(6) The control method according to (5), in which
   the roll angle of the gimbal is controlled on the basis of the yaw angle of the gimbal.
(7) The control method according to (6), in which
   the roll angle of the gimbal is controlled on the basis of an angle difference between the yaw angle of the flying object and the yaw angle of the gimbal.
(8) The control method according to (7), in which
   the roll angle of the gimbal is controlled on the basis of a reflection rate indicating how much the roll angle of the flying object is reflected in the roll angle of the gimbal.
(9) The control method according to (7) or (8), in which
   when the angle difference is 0°, the roll angle of the gimbal is controlled such that the roll angle of the gimbal takes a value identical to a value of the roll angle of the flying object.
(10) The control method according to (9), in which
   when the angle difference is 180°, the roll angle of the gimbal is controlled such that the roll angle of the gimbal takes a value identical to a value of the roll angle of the flying object in an opposite direction.
(11) The control method according to (10), in which
   when the angle difference is 90° and −90°, the roll angle of the gimbal is controlled such that the roll angle of the gimbal is 0° regardless of the roll angle of the flying object.
(12) The control method according to (11), in which
   when the angle difference Δ is 0°<Δθ<90°, the roll angle of the gimbal is controlled such that the roll angle of the gimbal gradually decreases as the angle difference increases.
(13) The control method according to (12), in which
   when the angle difference Δθ is 90°<Δθ<180°, the roll angle of the gimbal is controlled such that the roll angle of the gimbal gradually increases in an opposite direction of a case where 0°<Δθ<90° as the angle difference increases.
(14) The control method according to any one of (11) to (13), in which
   when the angle difference Δθ is 0°>Δθ>−90°, the roll angle of the gimbal is controlled such that the roll angle of the gimbal gradually decreases as an absolute value of the angle difference increases.
(15) The control method according to (14), in which
   when the angle difference is 90°>Δθ>−180°, the roll angle of the gimbal is controlled such that the roll angle of the gimbal gradually increases in an opposite direction of a case where 0°>Δθ>−90° as the absolute value of the angle difference Δθ increases.
(16) The control method according to any one of (8) to (15), in which
   the roll angle of the gimbal is calculated by the following equations,

$$roll\_b = sin φ 1 ,$$

$$roll\_g = roll\_b \times cos Δ θ , and$$

$$φ 2 = a \times atan ( roll\_g / {( {1}^{2} - {roll\_g}^{2} )}^{1 / 2} ) ,$$

where φ1 is the roll angle of the flying object, Δθ is the angle difference, φ2 is the roll angle of the gimbal, and a is the reflection rate.
(17) The control method according to any one of (1) to (18), in which
   the pitch angle of the gimbal is changed in accordance with an orientation of a velocity vector in a movement of the flying object.
(18) The control method according to (17), in which
   the pitch angle of the gimbal is changed in accordance with an angle at which the velocity vector is tilted with respect to a horizontal direction.
(19) The control method according to (18), in which
   the pitch angle of the gimbal is changed such that the pitch angle of the gimbal matches the angle at which the velocity vector is tilted with respect to the horizontal direction.
(20) The control method according to any one of (17) to (19), in which
   under a first condition, the pitch angle of the gimbal is changed such that a front orientation of the camera obtained by a change in pitch angle of the gimbal is an orientation identical to the velocity vector of the flying object.
(21) The control method according to (20), in which
   under a second condition different from the first condition, the pitch angle of the gimbal is changed such that the front orientation of the camera obtained by the change in pitch angle of the gimbal is an opposite orientation of the velocity vector of the flying object.
(22) The control method according to (21), in which
   the first condition is that a yaw angle difference between a horizontal component of the velocity vector and the yaw angle of the gimbal is equal to or smaller than ±90°.
(23) The control method according to (22), in which
   the second condition is that the yaw angle difference between the horizontal component of the velocity vector and the yaw angle of the gimbal exceeds ±90°.
(24) A control method, including
   changing a pitch angle of a gimbal in accordance with an orientation of a velocity vector in a movement of a flying object, the gimbal being installed on the flying object and capable of rotating a camera in a pitch direction.
(25) A gimbal, including
   a control unit that
      controls a pitch angle of the gimbal independently of a pitch angle of a flying object, the gimbal being installed on the flying object and capable of rotating a camera in a pitch direction and a roll direction, and
      controls a roll angle of the gimbal in correlation with a roll angle of the flying object.
(26) A flying object, including
   a control unit that
      controls a pitch angle of a gimbal independently of a pitch angle of the flying object, the gimbal being installed on the flying object and capable of rotating a camera in a pitch direction and a roll direction, and
      controls a roll angle of the gimbal in correlation with a roll angle of the flying object.
(27) A gimbaled flying object, including
   a control unit that
      controls a pitch angle of a gimbal independently of a pitch angle of a flying object, the gimbal being installed on the flying object and capable of rotating a camera in a pitch direction and a roll direction, and
      controls a roll angle of the gimbal in correlation with a roll angle of the flying object.
(28) A program that causes a computer to execute processing of
   controlling a pitch angle of a gimbal independently of a pitch angle of a flying object, the gimbal being installed on the flying object and capable of rotating a camera in a pitch direction and a roll direction, and
   controlling a roll angle of the gimbal in correlation with a roll angle of the flying object.

### REFERENCE SIGNS LIST

10 gimbaled drone
11 drone
12 airframe
30 gimbal
31 camera
40 controller
100 control system

1. A control method, comprising:
controlling a pitch angle of a gimbal independently of a pitch angle of a flying object, the gimbal being installed on the flying object and capable of rotating a camera in a pitch direction and a roll direction; and
controlling a roll angle of the gimbal in correlation with a roll angle of the flying object.

2. The control method according to claim 1, wherein
the gimbal is capable of rotating the camera in a yaw direction, and
the control method further comprises
controlling a yaw angle of the gimbal independently of a yaw angle of the flying object, or
controlling the yaw angle of the gimbal in correlation with the yaw angle of the flying object.

3. The control method according to claim 1, wherein
the gimbal is capable of rotating the camera in a yaw direction, and
the control method further comprises
controlling a yaw angle of the gimbal independently of a yaw angle of the flying object, and
controlling the roll angle of the gimbal on a basis of the roll angle of the flying object.

4. The control method according to claim 3, wherein
the roll angle of the gimbal is controlled on a basis of the yaw angle of the flying object or the yaw angle of the gimbal.

5. The control method according to claim 4, wherein
the roll angle of the gimbal is controlled on a basis of an angle difference between the yaw angle of the flying object and the yaw angle of the gimbal.

6. The control method according to claim 5, wherein
the roll angle of the gimbal is controlled on a basis of a reflection rate indicating how much the roll angle of the flying object is reflected in the roll angle of the gimbal.

7. The control method according to claim 5, wherein
when the angle difference is 0°, the roll angle of the gimbal is controlled such that the roll angle of the gimbal takes a value identical to a value of the roll angle of the flying object.

8. The control method according to claim 7, wherein
when the angle difference is 180°, the roll angle of the gimbal is controlled such that the roll angle of the gimbal takes a value identical to a value of the roll angle of the flying object in an opposite direction.

9. The control method according to claim 8, wherein
when the angle difference is 90° and −90°, the roll angle of the gimbal is controlled such that the roll angle of the gimbal is 0° regardless of the roll angle of the flying object.

10. The control method according to claim 9, wherein
when the angle difference Δ is 0°<Δθ<90°, the roll angle of the gimbal is controlled such that the roll angle of the gimbal gradually decreases as the angle difference increases.

11. The control method according to claim 10, wherein
when the angle difference Δθ is 90°<Δθ<180°, the roll angle of the gimbal is controlled such that the roll angle of the gimbal gradually increases in an opposite direction of a case where 0°<Δθ<90° as the angle difference increases.

12. The control method according to claim 9, wherein
when the angle difference Δθ is 0°>Δθ>−90°, the roll angle of the gimbal is controlled such that the roll angle of the gimbal gradually decreases as an absolute value of the angle difference increases.

13. The control method according to claim 12, wherein
when the angle difference is 90°>Δθ>−180°, the roll angle of the gimbal is controlled such that the roll angle of the gimbal gradually increases in an opposite direction of a case where 0°>Δθ>−90° as the absolute value of the angle difference Δθ increases.

14. The control method according to claim 6, wherein
the roll angle of the gimbal is calculated by the following equations,
$$roll\_b = sin φ 1 ,$$
$$roll\_g = roll\_b \times cos Δ θ , and$$
$$φ 2 = a \times atan ( roll\_g / {( {1}^{2} - {roll\_g}^{2} )}^{1 / 2} ) ,$$
where φ1 is the roll angle of the flying object, Δθ is the angle difference, φ2 is the roll angle of the gimbal, and a is the reflection rate.

15. The control method according to claim 1, wherein
the pitch angle of the gimbal is changed in accordance with an orientation of a velocity vector in a movement of the flying object.

16. The control method according to claim 15, wherein
the pitch angle of the gimbal is changed in accordance with an angle at which the velocity vector is tilted with respect to a horizontal direction.

17. The control method according to claim 16, wherein
the pitch angle of the gimbal is changed such that the pitch angle of the gimbal matches the angle at which the velocity vector is tilted with respect to the horizontal direction.

18. The control method according to claim 15, wherein
when a yaw angle difference between a horizontal component of the velocity vector and the yaw angle of the gimbal is equal to or smaller than ±90°, the pitch angle of the gimbal is changed such that a front orientation of the camera obtained by a change in pitch angle of the gimbal is an orientation identical to the velocity vector of the flying object.

19. The control method according to claim 18, wherein
when the yaw angle difference between the horizontal component of the velocity vector and the yaw angle of the gimbal exceeds ±90°, the pitch angle of the gimbal is changed such that the front orientation of the camera obtained by the change in pitch angle of the gimbal is an opposite orientation of the velocity vector of the flying object.

20. A control method, comprising
changing a pitch angle of a gimbal in accordance with an orientation of a velocity vector in a movement of a flying object, the gimbal being installed on the flying object and capable of rotating a camera in a pitch direction.
